(19) United States
(12) Patent Application Publication
(10) Pub. No.: US 2021/0202994 A1
(43) Pub. Date: Jul. 1, 2021

(54) NON-AQUEOUS ELECTROLYTE AND NON-AQUEOUS ELECTROLYTE SECONDARY BATTERY

(71) Applicant: Toyota Jidosha Kabushiki Kaisha, Toyota-shi Aichi-ken (JP)

(72) Inventor: Hiroto Asano, Nisshin-shi (JP)

(73) Assignee: Toyota Jidosha Kabushiki Kaisha, Toyota-shi Aichi-ken (JP)

(21) Appl. No.: 17/111,990

(22) Filed: Dec. 4, 2020

(30) Foreign Application Priority Data
Dec. 27, 2019 (JP) 2019-238262

(51) Int. Cl. H01M 10/0567; H01M 10/0525; H01M 4/583; H01M 4/133

(52) U.S. Cl. CPC H01M 10/0567; H01M 10/0525; H01M 2300/0037; H01M 4/133; H01M 4/583

(57) ABSTRACT

A non-aqueous electrolyte disclosed herein contains a difluorophosphate represented by the following formula (I) with 0.5% by mass or more and a silyl sulfate compound represented by the following formula (II) with 0.1% by mass or more. M⁺ in the following formula (I) represents an alkali metal ion. R¹ to R⁶ in the following formula (II) are independent of each other and each represent an alkyl group that has 1 to 4 carbon atoms and that is optionally substituted with a fluorine atom, an alkenyl group that has 2 to 4 carbon atoms and that is optionally substituted with a fluorine atom, an alkyl group having 2 to 4 carbon atoms, in which an oxygen atom is inserted between a carbon-carbon bond, or an alkenyl group having 3 to 4 carbon atoms, in which an oxygen atom is inserted between a carbon-carbon bond.

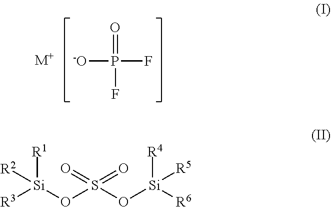

### CROSS-REFERENCE TO RELATED APPLICATIONS

This application claims priority to Japanese Patent Application No. 2019-238262 filed on Dec. 27, 2019, which is incorporated herein by reference in its entirety including the specification, drawings and abstract.

### BACKGROUND

### 1. Technical Field

The disclosure relates to a non-aqueous electrolyte used for a secondary battery. The disclosure also relates to a non-aqueous electrolyte secondary battery constructed using the non-aqueous electrolyte.

### 2. Description of Related Art

Secondary batteries are used as a power source for a wide range of applications. Particularly in recent years, a high-output and high-capacity secondary battery has been adopted as a vehicle driving power source or a power storing power source for electric vehicles (EVs), hybrid vehicles (HVs), plug-in hybrid vehicles (PHVs), and the like. Examples of such a secondary battery include a lithium ion secondary battery or a sodium ion secondary battery, in which a charge carrier is a predetermined metal ion and an electrolyte is an organic (non-aqueous) electrolyte, that is, a non-aqueous electrolyte. Further improvement in the used non-aqueous electrolyte can be considered as an approach to improve the performance of such a non-aqueous electrolyte secondary battery. For example, Japanese Unexamined Patent Application Publication No. 11-067270 (JP 11-067270 A) describes a non-aqueous electrolyte containing lithium monofluorophosphate or lithium difluorophosphate for reducing self-discharge characteristics and improve storage characteristics. Further, Japanese Unexamined Patent Application Publication No. 2002-359001 (JP 2002-359001 A) describes a non-aqueous electrolyte containing a compound such as bis(trimethylsilyl) sulfate for the purpose of reducing internal resistance of a battery and improving various electrochemical characteristics.

### SUMMARY

However, according to a study made by the inventor of the disclosure, the non-aqueous electrolytes described in JP 11-067270 A and JP 2002-359001 A still have room for improvement. Particularly, a secondary battery to be used as a vehicle driving power source requires reduction in the initial resistance in an extremely low temperature range of 0° C. or lower (particularly −10° C. or lower, for example, about −30° C.) to improve the input/output characteristics. There is a need for development of a non-aqueous electrolyte that can improve such low temperature characteristics. The disclosure has been created to meet such requirements, and provides a non-aqueous electrolyte secondary battery and a non-aqueous electrolyte for the secondary battery which can improve the input/output characteristics in an extremely low temperature range.

A first aspect of the disclosure relates to a non-aqueous electrolyte used for a non-aqueous electrolyte secondary battery. The non-aqueous electrolyte contains a difluorophosphate represented by the following formula (I) with 0.5% by mass or more and a silyl sulfate compound represented by the following formula (II) with 0.1% by mass or more.

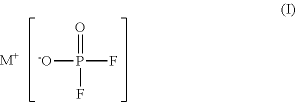

M⁺ in the formula (I) is an alkali metal ion.

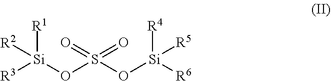

R¹ to R⁶ in the formula (II) are independent of each other and each represent an alkyl group that has 1 to 4 carbon atoms and that is optionally substituted with a fluorine atom, an alkenyl group that has 2 to 4 carbon atoms and that is optionally substituted with a fluorine atom, an alkyl group having 2 to 4 carbon atoms, in which an oxygen atom is inserted between a carbon-carbon bond, or an alkenyl group having 3 to 4 carbon atoms, in which an oxygen atom is inserted between a carbon-carbon bond.

The non-aqueous electrolyte having such a configuration contains both the difluorophosphate represented by the above formula (I) and the silyl sulfate compound represented by the above formula (II), and thus can reduce the initial resistance in an extremely low temperature range of 0° C. or lower, particularly −10° C. or lower, and can improve the input/output characteristics.

The silyl sulfate compound represented by the formula (II) may be at least one type selected from a group consisting of bis(trimethylsilyl) sulfate, bis(triethylsilyl) sulfate, and bis[dimethyl(methoxyethyl)silyl] sulfate. By adopting such a silyl sulfate compound, the input/output characteristics in an extremely low temperature range can be improved.

The non-aqueous electrolyte may include a solvent that belongs to at least one of carbonates as a non-aqueous solvent. By containing a solvent belonging to a carbonate (the non-aqueous solvent may be composed of a solvent belonging to a carbonate), a non-aqueous electrolyte used for a non-aqueous electrolyte secondary battery such as a lithium ion secondary battery is provided.

A second aspect of the disclosure provides a non-aqueous electrolyte secondary battery that includes any one of the above non-aqueous electrolytes as a non-aqueous electrolyte.

The non-aqueous electrolyte secondary battery disclosed herein can improve the input/output characteristics in an extremely low temperature range of 0° C. or lower and the high temperature storage characteristics (high temperature durability) as a result of constructing the non-aqueous electrolyte secondary battery using any one of the non-aqueous electrolytes described above.

### BRIEF DESCRIPTION OF THE DRAWINGS

Features, advantages, and technical and industrial significance of exemplary embodiments of the disclosure will be described below with reference to the accompanying drawings, in which like numerals denote like elements, and wherein:

FIG. 1 is a sectional view schematically showing an internal structure of a lithium ion secondary battery according to an embodiment of the disclosure; and

FIG. 2 is a schematic view showing a configuration of a wound electrode body of the lithium ion secondary battery of FIG. 1.

### DETAILED DESCRIPTION OF EMBODIMENTS

Hereinafter, some embodiments of an electrode structure disclosed herein will be described with reference to the drawings. Matters other than those particularly referred to in the present specification and necessary for carrying out the disclosure (for example, the general configuration and the manufacturing process of the entire secondary battery that do not characterize the disclosure) can be understood as matters of design choice for those skilled in the related art. The disclosure can be carried out based on contents disclosed in the present specification and common knowledge in the technical field.

In the present specification, the term “secondary battery” refers to a general electric storage device that can be repeatedly charged and discharged, and is a term that includes electric storage elements such as so-called storage batteries and electric double layer capacitors. Hereinafter, the disclosure will be described in detail with reference to a lithium ion secondary battery in which the non-aqueous electrolyte disclosed herein is used as an example, but it is not intended to limit the disclosure to the lithium ion secondary battery described in the embodiments. For example, a secondary battery including a non-aqueous electrolyte such as a sodium ion secondary battery or a magnesium ion secondary battery may be used, and an electric double layer capacitor such as a lithium ion capacitor may be used.

The electrolyte for a lithium ion secondary battery disclosed herein usually contains a non-aqueous solvent and a supporting salt. A known non-aqueous solvent used for the electrolyte for the lithium ion secondary battery may be used, and specific examples thereof include carbonates, ethers, esters, nitriles, sulfones, and lactones. In some embodiments, carbonates are used as the non-aqueous solvent. Examples of carbonates include ethylene carbonate (EC), propylene carbonate (PC), diethyl carbonate (DEC), dimethyl carbonate (DMC), ethylmethyl carbonate (EMC). These may be used singly or in combination of two or more.

In addition, a known supporting salt used as a supporting salt of an electrolyte for a lithium ion secondary battery can be used, and specific examples thereof include LiPF₆, LiBF₄, lithium bis(fluorosulfonyl)imide (LiFSI) and lithium bis(trifluoromethane)sulfonimide (LiTFSI). The concentration of the supporting salt in the electrolyte is not particularly limited, but is, for example, 0.5 mol/L or more and 5 mol/L or less, 0.7 mol/L or more and 2.5 mol/L or less, or 0.7 mol/L or more and 1.5 mol/L or less.

The content of difluorophosphate represented by the following formula (I) in the electrolyte for the lithium ion secondary battery disclosed herein is not particularly limited, but may be 0.2% by mass or more, or may be 0.5% by mass or more. When the content of the difluorophosphate is too small, the initial input/output resistance at an extremely low temperature increases. The upper limit of the content of the difluorophosphate is not particularly set, but may be 1.5% by mass or less. By setting the content within the above range, the initial input/output resistance at an extremely low temperature is suitably suppressed. Further, the content of a silyl sulfate compound represented by the following formula (II) may be 0.1% by mass or more. When the content of the silyl sulfate compound is too small, the initial input/output resistance in an extremely low temperature range increases. The upper limit of the content of the silyl sulfate compound is not particularly set, but may be 2.0% by mass or less. By setting the content within the above range, the initial input/output resistance at an extremely low temperature is suitably suppressed.

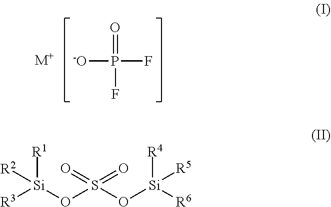

The inventor of the disclosure used a non-aqueous electrolyte containing the difluorophosphate represented by the above formula (I) (hereinafter sometimes referred to as “the above difluorophosphate”) and the silyl sulfate compound represented by the above formula (II) (hereinafter sometimes referred to as “the above silyl sulfate compound”) to actually prepare a lithium ion secondary battery and to conduct various analyses. Results of an X-ray photoelectron spectroscopy (XPS) analysis showed that a sulfur (S) element was incorporated in the form of SOx in the film formed on the electrode. Therefore, such SOx can be disclosed as a reaction product of the above silyl sulfate compound that is generated after the secondary battery is constructed, that is, after the activation process. Although not limited to the following operation mechanism, the following mechanism can be suggested. That is, a fluorine ion (F⁻) is released from the electrolyte salt containing a fluorine atom, and the ion is bonded to Si of the above silyl sulfate compound, whereby the Si—O bond is broken. As a result, a sulfate anion (SO₄²⁻) is generated. Further, the fluorophosphate is reductively decomposed to form a film on the electrode. At this time, it can be considered that such a sulfate anion is taken into the film and the sulfate anion is mixed in the film, whereby a film having a low resistance is generated.

The M⁺ in the above difluorophosphate is an alkali metal ion, and for example, lithium ion, sodium ion, potassium ion or the like is used. When the M⁺ of the above difluorophosphate is the lithium ion, it can be suitably used for the non-aqueous electrolyte for the lithium ion secondary battery.

In the above silyl sulfate compound, R¹ to R⁶ are independent of each other and each represent an alkyl group having 1 to 4 carbon atoms which may be substituted with a fluorine atom, an alkenyl group having 2 to 4 carbon atoms which may be substituted with a fluorine atom, a group having an oxygen atom inserted between carbon-carbon bonds of an alkyl group having 2 to 4 carbon atoms, or a group having an oxygen atom inserted between carbon-carbon bonds of an alkenyl group having 3 to 4 carbon atoms.

The alkyl group having 2 to 4 carbon atoms, which is represented by R¹ to R⁶ and may be substituted with a fluorine atom, may be linear or branched. In some embodiments, the alkyl group has 1 to 3 carbon atoms. When the alkyl group is substituted with a fluorine atom, the number of fluorine atoms is 1 to 5, or 1 to 3. Examples of the alkyl group include a methyl group, an ethyl group, an n-propyl group, an isopropyl group, an n-butyl group, an isobutyl group, a sec-butyl group, a tert-butyl group, and a group in which a hydrogen atom of the above groups is substituted with a fluorine atom. The alkenyl group having 2 to 4 carbon atoms, which is represented by R¹ to R⁶ and may be substituted with a fluorine atom, may be linear or branched. In some embodiments, the alkenyl group has 2 to 3 carbon atoms. When the alkenyl group is substituted with a fluorine atom, the number of fluorine atoms is 1 to 3. Examples of the alkenyl group include a vinyl group, an allyl group, a 1-propenyl group, a butenyl group, and a group in which a hydrogen atom of the above groups is substituted with a fluorine atom. The alkyl group represented by R¹ to R⁶ and having 2 to 4 carbon atoms, in which an oxygen atom is inserted between a carbon-carbon bond, may be linear or branched. In some embodiments, the group has 2 to 3 carbon atoms. In some embodiments, the number of oxygen atoms inserted into the group is 1. Examples of the group include a methoxymethyl group, an ethoxymethyl group, a methoxyethyl group, an ethoxyethyl group, and a methoxypropyl group. The alkenyl group represented by R¹ to R⁶ and having 3 to 4 carbon atoms, in which an oxygen atom is inserted between a carbon-carbon bond, may be linear or branched. In some embodiments, the number of oxygen atoms inserted into the group is 1. Examples of the group include a vinyloxymethyl group and a vinyloxyethyl group. In some embodiments, R¹ to R⁶ are a alkyl group having 1 to 4 carbon atoms and an alkyl group having 2 to 4 carbon atoms, in which an oxygen atom is inserted between a carbon-carbon bond, or an alkyl group having 1 to 3 carbon atoms, a methoxymethyl group, an ethoxymethyl group, and a methoxyethyl group.

As described above, R¹ to R⁶ can be selected independently of each other, but a silyl sulfate compound includes at least one of (or two of) a trimethylsilyl (TMS) group, a triethylsilyl (TES) group, and a dimethyl(2-methoxyethyl)silyl (DMMES) group.

The non-aqueous electrolyte for the lithium ion secondary battery disclosed herein may contain other components as long as the effects of the disclosure are not significantly impaired. Examples of the other components include gas generating agents such as biphenyl (BP) and cyclohexylbenzene (CHB), film forming agents, dispersants, and thickeners.

The electrolyte for the lithium ion secondary battery disclosed herein can be prepared by mixing the above components according to a known method. The method for preparing the electrolyte may be a known method in the related art, and detailed description thereof will be omitted. Further, the electrolyte for the lithium ion secondary battery disclosed herein can be used for a lithium ion secondary battery according to a known method. Furthermore, the manufacturing method of the lithium ion secondary battery disclosed herein is a manufacturing method of a secondary battery provided with the electrolyte for the lithium ion secondary battery described above. A method of manufacturing a secondary battery using an electrolyte other than the electrolyte disclosed herein may be a known method in the related art, and detailed description thereof will be omitted.

Next, an outline of a configuration of the lithium ion secondary battery including the electrolyte for the lithium ion secondary battery according to the present embodiment will be described below with reference to the drawings. In the following drawings, the same reference signs are given to the members and portions that have the same effect. The dimensional relationships (length, width, thickness, etc.) in the drawings do not show the actual dimensional relationships. Hereinafter, as an example, a rectangular lithium ion secondary battery including a flat wound electrode body is described, but the lithium ion secondary battery may be configured as a lithium ion secondary battery including a stacked electrode body. The lithium ion secondary battery can also be configured as a cylindrical lithium ion secondary battery, a laminated lithium ion secondary battery, or the like.

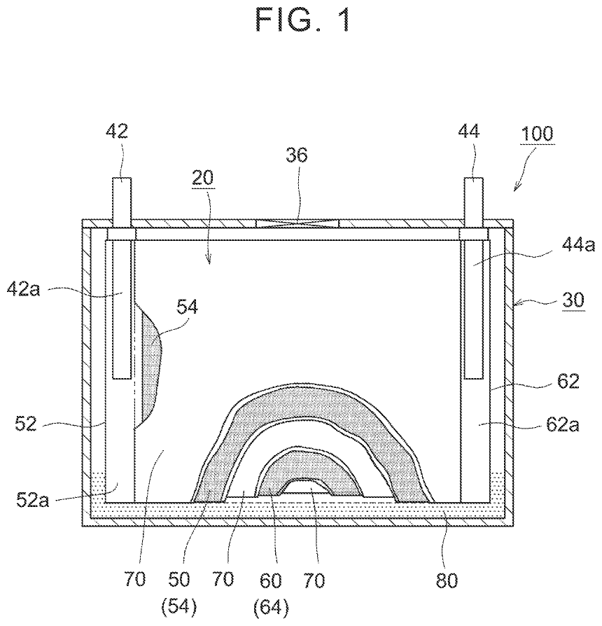

A lithium ion secondary battery 100 shown in FIG. 1 is a sealed battery constructed by housing a flat wound electrode body 20 and an electrolyte 80 in a flat rectangular battery case (that is, an outer container) 30. The battery case 30 is provided with a positive electrode terminal 42 and a negative electrode terminal 44 for external connection, and a thin safety valve 36 set to release the internal pressure of the battery case 30 when the internal pressure increases to a predetermined level or more. The battery case 30 is provided with an injection port (not shown) for injecting the electrolyte 80. The positive electrode terminal 42 is electrically connected to a positive electrode current collector plate 42a. The negative electrode terminal 44 is electrically connected to a negative electrode current collector plate 44a. As a material of the battery case 30, for example, a light-weight and highly heat-conductive metal material such as aluminum is used.

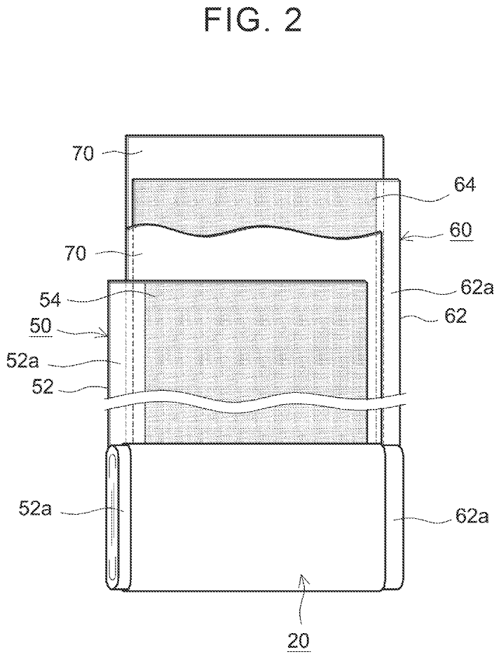

The wound electrode body 20 has a configuration in which, as shown in FIGS. 1 and 2, a positive electrode sheet 50 and a negative electrode sheet 60 are stacked via two long separator sheets 70 and are wound in the longitudinal direction. The positive electrode sheet 50 includes a positive electrode active material layer 54 provided on one surface or both surfaces (both surfaces in the present embodiment) of a long positive electrode current collector 52 along the longitudinal direction. The negative electrode sheet 60 includes a negative electrode active material layer 64 provided on one surface or both surfaces (both surfaces in the present embodiment) of a long negative electrode current collector 62 along the longitudinal direction. The positive electrode current collector plate 42a is joined to a positive electrode active material layer-free portion 52a (that is, the portion where the positive electrode current collector 52 is exposed without the positive electrode active material layer 54). The negative electrode current collector plate 44a is joined to a negative electrode active material layer-free portion 62a (that is, the portion where the negative electrode current collector 62 is exposed without the negative electrode active material layer 64). The positive electrode active material layer-free portion 52a and the negative electrode active material layer-free portion 62a are provided so as to protrude outward from both ends of the wound electrode body 20 in the winding axis direction (that is, the sheet width direction orthogonal to the longitudinal direction).

As the positive electrode sheet 50 and the negative electrode sheet 60, those used in the lithium ion secondary battery of the related art can be used without particular limitation. A typical mode is described below.

Examples of the positive electrode current collector 52 that constitutes the positive electrode sheet 50 include aluminum foil. Examples of the positive electrode active material contained in the positive electrode active material layer 54 include lithium transition metal oxides (e.g., LiNi_{1/3}Co_{1/3}Mn₃O₂, LiNiO₂, LiCoO₂, LiFeO₂, LiMn₂O₄, LiNi_{0.5}Mn_{1.5}O₄), and lithium transition metal phosphate compounds (e.g., LiFePO₄). The positive electrode active material layer 54 may include components other than the active material, such as a conductive material and a binder. As the conductive material, for example, carbon black such as acetylene black (AB) and other carbon materials such as graphite may be used. As the binder, for example, polyvinylidene fluoride (PVDF) or the like can be used.

Examples of the negative electrode current collector 62 that constitutes the negative electrode sheet 60 include copper foil. As the negative electrode active material contained in the negative electrode active material layer 64, a carbon material such as graphite, hard carbon, and soft carbon can be used. In some embodiments, graphite is the negative active material contained in the negative electrode active material layer 64. The graphite may be natural graphite or artificial graphite, and may be covered with an amorphous carbon material. The negative electrode active material layer 64 may include components other than the active material, such as a binder and a thickener. As the binder, for example, styrene butadiene rubber (SBR) or the like can be used. As the thickener, for example, carboxymethyl cellulose (CMC) or the like can be used.

In some embodiments, a porous sheet (film) made of polyolefin such as polyethylene (PE) or polypropylene (PP) is used as the separator 70. Such a porous sheet may have a single-layer structure or a stacked structure of two or more layers (for example, a three-layer structure in which a PP layer is laminated on both surfaces of a PE layer). A heat resistant layer (HRL) may be provided on the surface of the separator 70. The air permeability of the separator 70 obtained by the Gurley test method is not particularly limited, but, in some embodiments, is 350 seconds/100 cc or less.

As the electrolyte 80, the electrolyte for the lithium ion secondary battery according to the present embodiment described above is used. Note that FIG. 1 does not strictly show the amount of the electrolyte 80 to be injected into the battery case 30.

The lithium ion secondary battery 100 configured as described above can be used for various purposes. Suitable applications include a driving power source mounted on vehicles such as electric vehicles (EVs), hybrid vehicles (HVs), and plug-in hybrid vehicles (PHVs). The lithium ion secondary battery 100 can also be used in the mode of an assembled battery, in which a plurality of batteries is typically connected in series and/or in parallel.

Examples of the disclosure will be described below, but it is not intended to limit the disclosure to the examples shown in the Examples.

### Preparation of Non-Aqueous Electrolyte

As the non-aqueous solvent, a mixed solvent containing ethylene carbonate (EC), dimethyl carbonate (DMC), and ethyl methyl carbonate (EMC) at a volume ratio of 30:40:30 was prepared. LiPF₆ serving as a supporting salt was dissolved in the mixed solvent at a concentration of 1.0 mol/L, and the additive shown in Table 1 (the above difluorophosphate or the above silyl sulfate compound) was dissolved in the mixed solvent by an amount shown in Table 1 to prepare the electrolyte for each Example and each Comparative Example.

### Preparation of Lithium Ion Secondary Battery for Evaluation

LiNi_{1/3}Co_{1/3}Mn₃O₂ (LNCM) serving as a positive electrode active material powder, acetylene black (AB) serving as a conductive material, and polyvinylidene fluoride (PVdF) serving as a binder were mixed with N-methylpyrrolidone (NMP) at a mass ratio of LNCM:AB:PVdF=87:10:3 to prepare a slurry for forming a positive electrode active material layer. A positive electrode sheet was produced by applying the slurry to an aluminum foil and drying it. As a negative electrode active material, a natural graphite-based carbon material (C) having an average particle diameter of 20 m, styrene-butadiene rubber (SBR) serving as a binder, and carboxymethyl cellulose (CMC) serving as a thickener were mixed with ion-exchanged water at a mass ratio of C:SBR:CMC=98:1:1 to prepare a slurry for forming a negative electrode active material layer. A negative electrode sheet was produced by applying the slurry to a copper foil and drying it. Further, as the separator, a polyolefin porous film having a three-layer structure of PP, PE, PP in this order and having an air permeability of 200 seconds/100 cc obtained by the Gurley test method was prepared. The positive electrode sheet and the negative electrode sheet thus produced were overlapped with each other via the separators to produce an electrode body. After attaching current collectors to such an electrode body, the electrode body was housed and sealed in a laminated case together with the electrolyte prepared above. In this way, lithium ion secondary batteries for evaluation including the electrolytes for the Examples and the Comparative Examples were produced.

### Activation Process

Each of the lithium ion secondary batteries for evaluation prepared above was placed in a constant temperature bath kept at 25° C. Each of the lithium ion secondary batteries for evaluation was subjected to constant current charging at a current value of 0.3 C to 4.10 V, and then was subjected to constant current discharging at a current value of 0.3 C to 3.00 V. This charging/discharging was repeated three times.

### Initial Characteristic Evaluation

Each of the activated lithium ion secondary batteries for evaluation was placed in a constant temperature bath kept at 25° C. After performing constant current charging for each of the lithium ion secondary batteries for evaluation at a current value of 0.2 C to 4.10 V, constant voltage charging was performed until the current value became 1/50 C to obtain a fully charged state (state of charge (SOC): 100%). Then, constant current discharging was performed at a current value of 0.2 C to 3.00 V. The discharge capacity at this time was measured and used as the initial capacity. Each of the activated lithium ion secondary batteries for evaluation was placed in a constant temperature bath kept at 25° C. and constant current charging was performed until the SOC reached 50% at a current value of 0.3 C. Then, in a constant temperature bath kept at −10° C. and −30° C., discharging and charging were performed at current values of 3 C, 5 C, 10 C, and 15 C for 10 seconds, and the battery voltages were measured each time. The current values and the voltage values were plotted with the current value on the horizontal axis and the voltage value on the vertical axis, and the IV resistance was determined from the inclination of the linear approximation line. This IV resistance was used as the initial resistance. Regarding the initial resistance of Comparative Example 1 as 100, the ratios of the initial resistance of the Examples and other Comparative Examples were calculated. The obtained ratios are shown in Table 1.

TABLE 1

| | Content of additives in non-aqueous | | | | Initial resistance | |
|---|---|---|---|---|---|---|
| | electrolyte | | | | ratio | |
| | Additive | mass | Additive | mass | −10° C. | −30° C. |
| | (I) | % | (II) | % | input | output |
| Example 1 | LiPO₂F₂ | 1.5 | (TMS)₂SO₄ | 1.0 | 86 | 82 |
| Example 2 | LiPO₂F₂ | 1.0 | (TMS)₂SO₄ | 1.0 | 85 | 78 |
| Example 3 | LiPO₂F₂ | 0.5 | (TMS)₂SO₄ | 1.0 | 87 | 83 |
| Example 4 | LiPO₂F₂ | 1.0 | (TMS)₂SO₄ | 0.5 | 88 | 84 |
| Example 5 | LiPO₂F₂ | 1.0 | (TMS)₂SO₄ | 1.5 | 81 | 81 |
| Example 6 | LiPO₂F₂ | 1.0 | (TMS)₂SO₄ | 2.0 | 82 | 80 |
| Example 7 | LiPO₂F₂ | 1.0 | (TMS)₂SO₄ | 0.1 | 89 | 84 |
| Example 8 | LiPO₂F₂ | 1.0 | (TES)₂SO₄ | 1.0 | 84 | 80 |
| Example 9 | LiPO₂F₂ | 1.0 | (DMMES)₂SO₄ | 1.0 | 80 | 77 |
| Example | NaPO₂F₂ | 1.0 | (DMMES)₂SO₄ | 1.0 | 79 | 79 |
| 10 | | | | | | |
| Example | KPO₂F₂ | 1.0 | (DMMES)₂SO₄ | 1.0 | 80 | 82 |
| 11 | | | | | | |
| Compar- | Not | — | Not contained | — | 100 | 100 |
| ative | contained | | | | | |
| Example 1 | | | | | | |
| Compar- | LiPO₂F₂ | 1.0 | Not contained | — | 92 | 92 |
| ative | | | | | | |
| Example 2 | | | | | | |
| Compar- | Not | — | (TMS)₂SO₄ | 1.0 | 91 | 98 |
| ative | contained | | | | | |
| Example 3 | | | | | | |
| Compar- | LiPO₂F₂ | 1.0 | (TMS)₂SO₄ | 0.05 | 92 | 93 |
| ative | | | | | | |
| Example 4 | | | | | | |
| Compar- | LiPO₂F₂ | 0.1 | (TMS)₂SO₄ | 1.0 | 91 | 97 |
| ative | | | | | | |
| Example 5 | | | | | | |

The abbreviations in the table are as follows. (TMS)₂SO₄: bis(trimethylsilyl) sulfate (TES)₂SO₄: bis(triethylsilyl) sulfate (DMMES)₂SO₄: bis[dimethyl(2-methoxyethyl)silyl] sulfate

Hereinafter, Table 1 will be described. Further, “mass %” in Table 1 represents the ratio (%) of the mass of the additive (I) (the above difluorophosphate) or the additive (II) (the above silyl sulfate compound) contained in the non-aqueous electrolyte (100 mass %). Comparative Example 1 represents an electrolyte that is free of additives and that is commonly used in the related art. In Comparative Example 2, only LiPO₂F₂ was added as the additive with 1.0% by mass, and in Comparative Example 3, only (TMS)₂SO₄ was added as the additive with 1.0% by mass. Comparing Comparative Example 3 with Examples 1 to 3 (in which LiPO₂F₂ is added within a range of 0.5% by mass to 1.5% by mass and (TMS)₂SO₄ is added with 1.0% by mass), it can be understood that in Examples 1 to 3, as compared with Comparative Example 3, the initial input/output resistances at an extremely low temperature were suitably reduced. Further, in Comparative Example 5 (in which LiPO₂F₂ is added with 0.1% by mass and (TMS)₂SO₄ is added with 1.0% by mass), the value of the initial input resistance ratio at an extremely low temperature exceeded 90 (the value of the initial input resistance ratio is 90 or less) and the value of the initial output resistance ratio at an extremely low temperature exceeded 85 (the value of the initial output resistance ratio is 85 or less), which showed undesired results.

Comparing Comparative Example 2 with Examples 2 and 4 to 7 (in which LiPO₂F₂ is added with 1.0% by mass and (TMS)₂SO₄ is added within a range of 0.1% by mass to 2.0% by mass), it can be understood that in Examples 2 and 4 to 7, as compared with Comparative Example 2, the initial input/output resistances at an extremely low temperature were suitably reduced. Further, in Comparative Example 4 (in which LiPO₂F₂ is added with 1.0% by mass and (TMS)₂SO₄ is added with 0.05% by mass), the value of the initial input resistance ratio at an extremely low temperature exceeded 90 (the value of the initial input resistance ratio is 90 or less) and the value of the initial output resistance ratio at an extremely low temperature exceeded 85 (the value of the initial output resistance ratio is preferably 85 or less), which showed undesired results.

Comparing Example 2 and Examples 8 and 9, since only very small differences were confirmed in the values of the initial input/output resistance ratios at an extremely low temperature, it can be understood that the above silyl sulfate compound may be used regardless of whether the above silyl sulfate compound is (TMS)₂SO₄, (TES)₂SO₄, or (DMMES)₂SO₄. Further, comparing Example 9 and Examples 10 and 11, since only very small differences were confirmed in the values of the initial input/output resistance ratios at an extremely low temperature, it can be understood that the above difluorophosphate may be used regardless of whether the metal ion of the above difluorophosphate is lithium ion, sodium ion, or potassium ion.

From the above, it can be understood that the electrolyte for the lithium ion secondary battery according to the present embodiment suitably improves the input/output characteristics in an extremely low temperature range. It can also be understood that the lithium ion secondary battery including such an electrolyte suitably improves the input/output characteristics in an extremely low temperature range.

In addition, the inventor of the disclosure conducted the XPS analysis on a film on an electrode interface of the lithium ion secondary battery using the electrolyte described above. K-Alpha⁺ manufactured by Thermo Fisher Scientific was used for the XPS analysis, and the analysis was conducted according to the manual for the apparatus. Although details are not described, after the construction of the secondary battery, that is, after the activation process, the XPS analysis on the film on the negative electrode interface of the lithium ion secondary batteries in Comparative Example 1 and Example 2 was conducted while maintaining an inert atmosphere, and as a result, remarkable peaks attributed to the SOx and the POx were observed in Example 2. In Comparative Example 1, no peak of SOx was observed, and a relatively remarkable peak of POx was observed. From the above, it can be considered that, in Example 2, the film containing POx and SOx was formed on the negative electrode interface, and such a film contributed to improving the input/output characteristics at an extremely low temperature.

Further, in Example 2, as compared with Comparative Example 1, it was confirmed that the production of LiF was suppressed and the production of POx was accelerated (that is, a POx/LiF ratio changed). Therefore, by comparing the POx/LiF ratio with that of the battery in the related art through the XPS analysis, it is possible to show the presence of the reaction product of the above difluorophosphate in the secondary battery disclosed herein. Further, in ¹⁹F-NMR measurement, a peak of LiPO₂F₂ is observed (detected around −80 ppm as having a peak intensity much higher than that of LiPO₂F₂ which can be generated from LiPF₆ serving as a supporting salt), whereby the presence of the reaction product of the above difluorophosphate can be shown.

Specific examples of the disclosure have been described above in detail, but these are merely examples and do not limit the disclosure. The disclosure includes various modifications and changes of the specific examples illustrated above.

What is claimed is:

1. A non-aqueous electrolyte for a non-aqueous electrolyte secondary battery, the non-aqueous electrolyte containing a difluorophosphate represented by the following formula (I) with 0.5% by mass or more and a silyl sulfate compound represented by the following formula (II) with 0.1% by mass or more, wherein: 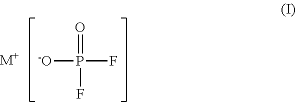
M⁺ in the formula (I) is an alkali metal ion; and 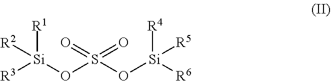
R¹ to R⁶ in the formula (II) are independent of each other and each represent an alkyl group that has 1 to 4 carbon atoms and that is optionally substituted with a fluorine atom, an alkenyl group that has 2 to 4 carbon atoms and that is optionally substituted with a fluorine atom, an alkyl group having 2 to 4 carbon atoms, in which an oxygen atom is inserted between a carbon-carbon bond, or an alkenyl group having 3 to 4 carbon atoms, in which an oxygen atom is inserted between a carbon-carbon bond.

2. The non-aqueous electrolyte according to claim 1, wherein the silyl sulfate compound represented by the formula (II) is at least one selected from a group consisting of bis(trimethylsilyl) sulfate, bis(triethylsilyl) sulfate, and bis[dimethyl(methoxyethyl)silyl]sulfate.

3. The non-aqueous electrolyte according to claim 1, comprising a solvent that belongs to at least one of carbonates as a non-aqueous solvent.

4. A non-aqueous electrolyte secondary battery, which is a secondary battery including a non-aqueous electrolyte, wherein the non-aqueous electrolyte satisfies one of the following conditions (1) and (2):
(1) the non-aqueous electrolyte contains a difluorophosphate represented by the following formula (I) 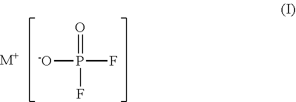
and a silyl sulfate compound represented by the following formula (II), wherein 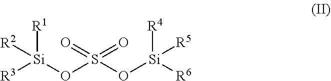
M⁺ in the formula (I) is an alkali metal ion, and
R¹ to R⁶ in the formula (II) are independent of each other and each represent an alkyl group that has 1 to 4 carbon atoms and that is optionally substituted with a fluorine atom, an alkenyl group that has 2 to 4 carbon atoms and that is optionally substituted with a fluorine atom, an alkyl group having 2 to 4 carbon atoms, in which an oxygen atom is inserted between a carbon-carbon bond, or an alkenyl group having 3 to 4 carbon atoms, in which an oxygen atom is inserted between a carbon-carbon bond; and
(2) the non-aqueous electrolyte contains a reaction product of the difluorophosphate represented by the formula (I) and a reaction product of the silyl sulfate compound represented by the formula (II).

5. The non-aqueous electrolyte secondary battery according to claim 4, wherein the silyl sulfate compound represented by the formula (II) is at least one type selected from a group consisting of bis(trimethylsilyl) sulfate, bis(triethylsilyl) sulfate, and bis[dimethyl(methoxyethyl)silyl] sulfate.

6. The non-aqueous electrolyte secondary battery according to claim 4, wherein the non-aqueous electrolyte contains a solvent that belongs to at least one of carbonates as a non-aqueous solvent.
